(19) United States
(12) Patent Application Publication
(10) Pub. No.: US 2025/0189056 A1
(43) Pub. Date: Jun. 12, 2025

(54) PRE-MOUNTABLE CONTROL ROD ASSEMBLY AND COUPLING STRUCTURE FOR A CONTROL VALVE FOR ADJUSTING A PROCESS FLUID FLOW, AND CONTROL VALVE AND METHOD FOR MOUNTING THE SAME

(71) Applicant: Samson Aktiengesellschaft, Frankfurt am Main (DE)

(72) Inventors: Sabine Weber, Frankfurt (DE); Johannes Jantz, Schmitten (DE); Andreas Reinthaler, Wiesbaden (DE); Daniel Gränz, Eschborn (DE)

(73) Assignee: Samson Aktiengesellschaft, Frankfurt am Main (DE)

(21) Appl. No.: 18/973,920

(22) Filed: Dec. 9, 2024

(30) Foreign Application Priority Data
Dec. 11, 2023 (DE) 102023134666.0

(51) Int. Cl. F16K 31/44; F16K 41/10

(52) U.S. Cl. CPC F16K 31/44; F16K 41/10

(57) ABSTRACT

A pre-mountable control rod assembly for providing a modular control valve having a plurality of different valve function- and construction configurations may include a substantially elongated control rod body with a control element sided end section to which several control elements are attachable to realize different process flows, a connecting flange which is arranged on a section of the substantially elongated control rod body opposite the control element sided end section, and a bellows seal which extends at least sectionally between the control element sided end section and the connecting flange.

### CROSS REFERENCE TO RELATED APPLICATIONS

This patent application claims priority to German Patent Application No. 10 2023 134 666.0, filed Dec. 11, 2023, which is incorporated herein by reference in its entirety.

### BACKGROUND

### Field

The present disclosure relates to a pre-mountable control rod assembly and a coupling structure, in particular a lantern, for a control valve for adjusting a process fluid flow of a process plant, such as a chemical plant, a power plant, a food processing plant, or the like. The disclosure also relates to a corresponding control valve and a method for its assembly.

### Related Art

A control valve may adjust a process fluid flow as described in DE 10 2022 124 163 A1. These control valves have a housing cover with a passage opening for a control rod, in which a stuffing box can be arranged. The stuffing box can be supported in the axial direction on a radial projection of the housing cover, possibly spring pretensioned, and held in the passage opening by a screw sleeve located opposite the radial projection in the axial direction. An axial pretensioning force can be exerted on the stuffing box with the screw sleeve and, if necessary, a spring, in order to bring about a radial contact pressure of the stuffing box on the control rod, so that leakage from the interior of the housing along the control rod is prevented with the aid of the stuffing box.

There is a need to improve the tightness of control valves at very high or low temperatures, aggressive process media and/or when there are special requirements for external tightness. Additionally, or alternatively, there is a need to facilitate the assembly of the individual components and/or the control valve as such or to realize a modular design for a control valve in which one or more components can be exchanged, renewed and/or replaced at any time, for example.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1A shows a pre-mountable control rod assembly according to the disclosure;

FIG. 1B shows an enlarged view of a connecting flange of the pre-mountable control rod assembly of FIG. 1A according to the disclosure;

FIG. 2 shows the pre-mountable control rod assembly of FIG. 1A according to the disclosure, which is inserted in a control valve, in particular a valve housing;

FIG. 3 shows a coupling structure according to the disclosure, in particular a lantern according to the disclosure, for a control valve;

FIG. 4 shows the pre-mountable control rod assembly according to the disclosure from FIG. 1A, which is inserted in a control valve, in particular a valve housing, wherein the additional coupling structure according to the disclosure, in particular the lantern, is provided as shown in FIG. 3; and

FIG. 5 shows a control valve according to the disclosure that comprises the pre-mountable control rod assembly of FIG. 1A according to the disclosure and the additional coupling structure according to the disclosure according to FIG. 3, which is arranged and/or attached between the valve housing and the housing cover.

The exemplary embodiments of the present disclosure will be described with reference to the accompanying drawings. Elements, features and components that are identical, functionally identical and have the same effect are—insofar as is not stated otherwise—respectively provided with the same reference character.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, and components have not been described in detail to avoid unnecessarily obscuring embodiments of the disclosure.

The drawings are schematic drawings that are not to scale. Some elements in the drawings may have exaggerated dimensions to emphasize aspects of the present disclosure and/or for better presentation clarity. For simplicity, identical reference signs are used to indicate identical elements, which are commonly included in the drawings. It is provided that elements and features of one embodiment may advantageously be incorporated into other embodiments without further mention. In general, only the differences with respect to individual embodiments are described. Substantially functionally identical elements may have the same reference number.

Each embodiment is designed to explain the disclosure and is not intended to be limiting of the disclosure. In addition, features shown or described as part of one embodiment may be used in conjunction with other embodiments to create another embodiment. It is intended that the description include such modifications and variations.

It is an object of the present disclosure to overcome the disadvantages of the conventional techniques and, in particular, to provide an improved control rod assembly and coupling structure, as well as an improved control valve and a corresponding method for its assembly.

One aspect of the disclosure relates to a pre-mountable control rod assembly for providing a modular control valve having a plurality of different valve function- and construction configurations, wherein the control valve is adapted to adjust a process fluid flow of a process plant, such as a chemical plant, a power plant, a food processing plant, or the like, comprising: a substantially elongated control rod body with a control element sided end section to which several, in particular different and/or identical, control elements for realizing different process flows are attachable, a connecting flange which is arranged on a section of the substantially elongated control rod body opposite the control element sided end section, and a bellows seal which extends at least sectionally between the control element sided end section and the connecting flange.

One aspect of the disclosure relates to a coupling structure, in particular a lantern, for reception of a pre-mountable control rod assembly, in particular according to one or more of the aspects of the disclosure and/or embodiments described herein, and for attachment between a valve housing and a housing cover of a control valve, wherein the control valve is adapted to adjust a process fluid flow of a process plant, such as a chemical plant, a power plant, a food processing plant, or the like, comprising: a substantially hollow-cylindrical base body with a through-opening, wherein the through-opening has a varying internal cross-section, in particular for attaching a connecting flange, wherein the internal cross-section decreases at least sectionally in the direction of a housing cover sided end section of the substantially hollow-cylindrical base body, in particular gradually, such as in a stepped manner.

One aspect of the disclosure relates to a coupling structure, in particular a lantern, in particular according to one or more of the aspects of the disclosure and/or embodiments described herein, for reception of a pre-mountable control rod assembly, in particular according to one or more of the aspects of the disclosure and/or embodiments described herein, and for attachment between a valve housing and a housing cover of a control valve, wherein the control valve is adapted to adjust a process fluid flow of a process plant, such as a chemical plant, a power plant, a food processing plant, or the like, comprising a substantially hollow-cylindrical base body with a through-opening, wherein the substantially hollow-cylindrical base body, in particular on a valve housing sided end face, has a projection, in particular a fixing projection, which is dimensioned and/or arranged such that, in particular in the assembled state of the coupling structure, in particular the lantern, it projects at least partially into the valve housing, in particular for providing a contact pressure for an adapter flange arrangeable therein.

One aspect of the disclosure relates to a control valve for adjusting a process fluid flow of a process plant, such as a chemical plant, a power plant, a food processing plant, or the like, wherein the control valve comprises: a valve housing having an inlet opening and an outlet opening, as well as a passage opening arranged therebetween; a housing cover arranged opposite the passage opening with a through-opening, and a pre-mountable control rod assembly according to one or more of the aspects of the disclosure and/or embodiments described herein, for providing the modular control valve with a plurality of different valve function- and construction configurations.

One aspect of the disclosure relates to a control valve, in particular according to one or more of the aspects of the disclosure and/or embodiments described herein, for adjusting a process fluid flow of a process plant, such as a chemical plant, a power plant, a food processing plant, or the like, wherein the control valve comprises: a valve housing having an inlet opening and an outlet opening, as well as a passage opening arranged therebetween; a housing cover arranged opposite the passage opening with a through-opening, and a coupling structure, in particular a lantern, according to one or more of the aspects of the disclosure and/or embodiments described herein, between the valve housing and the housing cover.

One aspect of the disclosure relates to a method of assembling a control valve, in particular according to one or more of the aspects of the disclosure and/or embodiments described herein, comprising: inserting a pre-mountable control rod assembly according to one or more of the aspects of the disclosure and/or embodiments described herein, into a valve body; guiding a penetration opening of an adapter flange and/or one or more insert sleeves, in particular reversibly, attachable or attached to the adapter flange through the pre-mountable control rod assembly; placing the coupling structure, in particular the lantern, according to one or more of the aspects of the disclosure and/or embodiments described herein, on the pre-mountable control rod assembly.

When reference is made herein to a pre-mountable control rod assembly, a coupling structure, in particular a lantern, a control valve, or a method, this refers to the pre-mountable control rod assembly according to the disclosure, the coupling structure, in particular the lantern, according to the disclosure, the control valve according to the disclosure or the method according to the disclosure. It should also be understood that features, aspects and/or embodiments relating to the control valve according to the disclosure as such and/or its components according to the disclosure, for example the pre-mountable control rod assembly and/or the coupling structure, in particular the lantern, are also applicable, relevant and/or transferable, individually or in combination, to the method according to the disclosure and vice versa.

A “control rod assembly” can be understood as an assembly suitable for a control valve, for example a control valve for adjusting a process fluid flow of a process plant, such as a chemical plant, a power plant, a food processing plant, or the like.

The control rod assembly and/or the control valve as such may have a modular structure or design which allows, for example, one or more, e.g. different, components, parts and/or elements of the control rod assembly and/or the control valve to be combined, assembled and/or replaced, e.g. as required. For example, individual components, parts and/or elements can be easily installed and/or removed, replaced and/or renewed, e.g. for maintenance purposes, for example without necessarily having to dismantle the entire control valve and/or without having to replace the entire valve or several, for example connected, assemblies. This saves resources and time and enables greater flexibility. The control rod assembly and/or control valve described herein may be referred to as a modular control rod assembly and/or a modular control valve; thus, these terms may be used interchangeably.

The control valve can comprise a valve housing and a housing cover. The valve housing may comprise an inlet opening and an outlet opening as well as a passage opening arranged therebetween. The control valve may also comprise a valve seat which may surround the passage opening. The valve seat may be fully circular. Furthermore, the control valve may comprise a control element which is movable in the valve housing and which may be attached to a control rod, for example the pre-mountable control rod assembly described herein. The control element can be brought into sealing engagement with the valve seat. The valve seat and the control element can be matched to one another for sealing engagement. The housing cover may have a through-opening for the control rod and/or the pre-mountable control rod assembly described herein, in particular the control rod body thereof. The housing cover may be arranged opposite the passage opening. The housing cover may be attached or attachable to the valve housing. The control valve can comprise a control element that is translationally movable along a stroke axis, such as a stroke valve element, for example a valve piston or valve plug. The control element is adapted to adjust a process fluid flow in a process plant. The control valve can be equipped with an insert arrangement for guiding the control element, for example with a mounting flange that can be inserted between the valve housing and housing cover and can comprise a reversibly attachable or attached insert sleeve for guiding the control element.

The valve housing, which may also be referred to as a housing body, may include a process fluid inlet, a process fluid outlet and a process fluid passageway arranged between the process fluid inlet and the process fluid outlet. Further, the housing body may include an actuation opening for inserting the control element and/or a control rod and/or a pre-mountable control rod assembly described herein for actuating the control element along the stroke axis. At the process fluid inlet and at the process fluid outlet of the valve housing, mounting devices, for example flange-like attachment sections, can be provided for connecting a pipeline for guiding the process fluid. A valve seat can be provided on the process fluid passage of the valve housing, which can cooperate with the control element in a closing and/or opening manner. The valve seat can be an annular and/or case-shaped seat of an insertable component. The valve seat can have one or more sealing surfaces for sealing cooperation with the control element, in particular a valve piston or valve cone. One (or more) sealing devices, such as a ring seal, can be arranged between the valve seat and the valve housing.

The valve housing can be a in particular one-piece body made of one or more media- and/or temperature-resistant materials. For example, the valve housing can be a one-piece cast metal body or forged body that is sectionally coated with a machined, for example polished and/or coated, for example painted, powder-coated, chrome-plated, enameled, galvanized or similar, surface. The valve housing may define an internal housing space, the openings of which may be realized exclusively by the process fluid inlet, the process fluid outlet and the actuation opening. It is conceivable that a housing body has further openings to the inner space, for example openings for the introduction of sensors or one or more further process fluid inlets or outlets.

The housing cover is arranged and adapted to cover the actuating opening. The housing cover can have a through-opening extending in the direction of the stroke axis for receiving the control rod and/or the pre-mountable control rod assembly described herein. In particular, the housing cover may comprise an attachment section for mounting an actuator, in particular a pneumatic actuator, or a yoke, a coupling structure, in particular a lantern or the like for supporting an actuator. A corresponding attachment section can also be provided on the valve housing. The through-opening can be free of sealing means for sealing between the housing cover and the control rod or the pre-mountable control rod assembly. The through-opening may be free of guides, such as a plain bearing, a ball bearing or the like, for translationally guiding the control element. With regard to a control rod and/or the control rod of the pre-mountable control rod assembly, the housing cover can be dimensioned such that the smallest clear width, in particular the smallest inner diameter, of the housing cover, in particular the through-opening, is larger than the outer diameter of the control rod and/or the control rod of the pre-mountable control rod assembly in the region extending through the through-opening of the housing cover. The housing cover can be formed from a temperature- and/or media-resistant material. It is conceivable that the same material is selected for the valve housing and the housing cover. The housing cover and the valve housing can be in direct contact with the housing body for mounting the housing cover. For example, the housing body and the housing cover can have corresponding flange sections for attaching the housing cover to the housing body. A coupling structure, in particular a lantern, can also be provided between them, but this is not mandatory. The housing cover can have a plate-like cover section, which may be designed to completely close the actuating opening of the valve housing in the radial direction and in the circumferential direction with respect to the stroke axis, with the exception of the through-opening.

The control valves of the process plant can be embodiments according to the disclosure in various ways, i.e. the control valves need not be identical. In particular, the process plant can comprise a plurality of control valves according to the disclosure with similar valve housings, housing covers, mounting flanges, coupling structures, in particular lanterns (if present), and/or different types of insert sleeves and/or control elements. The disclosure can also comprise a set of process control valves for one or more process plants, which has a plurality of similar valve housings, a plurality of similar housing covers, a plurality of similar coupling structures, in particular lanterns (if present), and/or a plurality of similar mounting flanges, and/or a plurality of different insert sleeves and/or a plurality of different control elements.

The process plant with several control valves can comprise at least two different, in particular similar, mounting flanges and/or two different insert sleeves and/or two different control elements, wherein the insert sleeves of the several control valves are insertable alternately into the different mounting flanges.

The pre-mountable control rod assembly may be embodied as a modular adapter system and may be compatible with a plurality of different and/or similar control elements. For example, the pre-mountable control rod assembly may comprise a plurality of different and/or similar control elements, in particular all of which are assembly-compatible therewith, for example to realize or provide several different, in particular individual, valve function- and construction configurations and/or to realize a modular control valve. Exemplary control elements include a piston for a cage valve, a V-port plug or the like.

The pre-mountable control rod assembly, or the modular adapter system, can furthermore be extendable by and/or compatible with a mounting flange and one or more insert sleeves arrangeable therein or comprise the same, for example with several different insert sleeves, each for an individual functional- or construction configuration for a control valve.

For example, the pre-mountable control rod assembly may include a plurality of different and/or similar mounting flanges and/or insert sleeves for configuring the control valve by construction, e.g. as a cone valve. For example, one individual adapter insert sleeve each may be provided for a configuration of the control valve as an emergency-close valve, emergency-open valve, pressure-balanced control or closing valve or the like. For example, one insert sleeve of different configurations of a cone valve can be defined for example for different control ranges, in particular a nominal flow rate, a minimum flow rate (or a closing movement) and/or a maximum flow rate, in particular with regard to a specific process medium and/or a specific process pressure range. It is also conceivable that different insert sleeves can be provided for different cage valve configurations for providing differently configured control valves.

It should be understood that in the pre-mountable control rod assembly and/or the modular adapter system, the same housing body, the same housing cover, the same coupling structure, in particular the same lantern (if present) and the same mounting flange may be provided for the different function- or construction configurations, wherein the function- or construction configuration may be defined by a respective insert sleeve and/or the respective control element.

In particular, the same housing cover, the same coupling structure, in particular the same lantern (if present) and the same housing body and the same mounting flange can be used in conjunction with a function- and/or construction configuration adapter, which can be freely selected from a range of different insert connections, but which are all mounting-compatible with respect to the same mounting flange.

By selecting a suitable insert sleeve and/or a suitable control element for the conditions prevailing in a respective associated process, a control valve can be easily configured to suit without requiring a completely new construction of the valve. This also allows individual components, parts and/or elements to be easily exchanged, renewed, maintained, replaced, assembled, disassembled and/or repaired, thus enabling a modular setup.

A “control rod assembly” can be understood as an assembly suitable for a control valve described herein, for example a modular control valve. The control rod assembly may be, for example, an assembly, combination, collection and/or arrangement of components, parts or elements comprising at least one control rod, for example a control rod body, and at least one further component, at least one further part or at least one further element connected to and/or connectable to and/or attachable to the control rod, for example the control rod body. As explained below, this may, for example, be a connecting flange and/or a sealing means, for example a bellows seal.

The control rod assembly can be “pre-mountable” and/or “pre-mounted”. This can be understood to mean, for example, that the control rod assembly can also be mounted and/or assembled and/or disassembled outside the control valve, e.g. even before the intended use and/or the intended place of use, for example the final mounting position in the control valve. For example, the pre-mountable control rod assembly can be pre-mountable and/or pre-mounted in such a way that it only needs to be inserted into the control valve, for example the valve housing, e.g. at a later point in time, without having to remove and reinstall the individual components one by one, e.g. one after the other. On the one hand, this makes assembly easier and, on the other, ensures greater flexibility. It is also possible to leave the control rod assembly in the control valve, e.g. in order to exchange and/or replace other components and/or parts of the control valve. For example, the mounting flange and/or the insert sleeve attached or attachable therein can be removed, replaced, renewed and/or exchanged even if the control rod assembly is or remains inserted in the control valve. For example, the mounting flange and/or the insert sleeve attached or attachable therein can simply be guided or slid over the control rod assembly to remove it from the control valve. This facilitates the assembly or disassembly of the control valve. The sizes, measurements and/or dimensions of the control rod assembly and/or its components or parts can be adapted, matched and/or adjusted in order to realize these advantages.

The pre-mountable control rod assembly may have a substantially elongated control rod body. “Substantially elongated” herein can mean in particular that a body, for example the control rod body, for example along or in the direction of a stroke axis of the control valve or the control element, has a larger dimension than in the radial direction, for example transversely to the stroke axis, i.e. the control rod body is long or elongated rather than wide or high.

The substantially elongated control rod body can have two, in particular opposite, end sections. Several, in particular different and/or identical, control elements for realizing different process flows can be attachable to one end section of the substantially elongated control rod body. This end section can therefore be referred to as the control element sided end section. The other end section may, for example, be located in the region of the housing cover of the control valve, wherein this region may be referred to as the housing cover sided end section. The substantially elongated control rod body may have a constant cross-section and/or diameter, in particular outer diameter. The cross-section may also change, for example in the longitudinal direction, for example in an abrupt and/or stepped manner. For example, one section of the substantially elongated control rod body, for example in the assembled state, for example in the region of the housing cover and/or a housing cover sided end section of a coupling structure, in particular a lantern, can have a smaller outer diameter than another section of the substantially elongated control rod body, for example in the region of the valve housing and/or a valve housing sided end section of the coupling structure, in particular the lantern.

The pre-mountable control rod assembly may comprise a connecting flange. The connecting flange can be arranged and/or adapted for engaging and/or connecting, in particular attaching, the control rod body to a coupling structure, in particular a lantern, attachable to a valve housing of the control valve, or to a housing cover of the control valve. The connecting flange may have a substantially hollow-cylinder-like connecting body. “Substantially hollow-cylinder-like” herein may describe a structure and/or shape that may substantially represent a cylindrical object that is hollow on the inside, similar to a tube. However, the structure and/or shape may merely have similarities with a hollow cylinder, i.e. there may be certain deviations and/or modifications from the exact cylinder shape, e.g. with regard to the inner/outer shape and/or its diameter. The connecting flange and/or the substantially hollow-cylinder-like connecting body may have a through-opening that extends, for example, in its longitudinal direction and/or in the direction of the stroke axis. The inner diameter of the through-opening can be at least sectionally matching and/or adapted to the outer diameter of the control rod body, in particular shape-matched and/or shape-adapted, for example to provide a guide for the control rod body. The through-opening can have a substantially constant cross-section and/or diameter. However, the cross-section and/or diameter a1 can also change, e.g. in the longitudinal direction, for example enlarge and/or widen, for example abruptly and/or in a stepped manner, for example to a diameter a2, wherein a1<a2 may apply. The change in cross-section and/or diameter, in particular on the inside, of the connecting flange can be matched and/or adapted to the change in cross-section and/or diameter, in particular on the outside, of the substantially elongated control rod body, for example for form-fit and/or form-complementary engagement. The connecting flange can be arranged on a section of the substantially elongated control rod body opposite the control element sided end section. For example, the connecting flange can be attached to the substantially elongated control rod body, e.g. in a sliding manner, so that it is moveable, relocatable, displaceable, dislocatable and/or shiftable or is guidable by the substantially elongated control rod body, e.g. translationally, in the longitudinal direction and/or or along the substantially elongated control rod body.

The connecting flange, in particular the substantially hollow-cylinder-like connecting body, can have an outer shape which is adapted for engagement and/or attachment with the coupling structure, in particular the lantern, or the housing cover of the control valve. For example, the substantially hollow-cylinder-like connecting body can have a section, in particular an attachment section, with a substantially constant outer diameter d, in particular in the longitudinal direction, which is adapted for attachment to the coupling structure, in particular the lantern, or the housing cover of the control valve. The attachment section can, for example, have a threaded section, in particular on the outside, for example for screwing to a mounting element such as a union nut or similar. The attachment section can be adjoined by a further section, in particular an engagement section, which can have a larger outer diameter than the outer diameter d of the attachment section. The attachment section and the engagement section can be formed in one piece, in particular by the substantially hollow-cylinder-like connecting body, for example from the same material, such as steel or steels, in particular CrNi steels and/or nickel-based alloys. The engagement section can have an outer contour that is formed in steps, for example the engagement section can have one or more steps that have one or more, in particular different, diameters, in particular outer diameters.

The connecting flange, in particular the engagement section, can have, in particular on the outside, at least one first shoulder, in particular a first radial shoulder. The radial shoulder can be designed and/or adapted for engaging, in particular in a form-fit and/or form-complementary manner, with the coupling structure, in particular the lantern, or the housing cover of the control valve. The first shoulder can be a circumferential shoulder that extends substantially around the entire circumference of the connecting flange. The diameter, in particular the outer diameter, d1 of the first shoulder can be larger than the diameter, in particular the outer diameter d, of the substantially hollow-cylinder-like connecting body, in particular the attachment section, wherein d1>d can apply.

The connecting flange, in particular the engagement section, can have at least one second shoulder, in particular a second radial shoulder, on the outside for reception of at least one sealing means. The radial shoulder can be a circumferential shoulder that extends substantially around the entire circumference of the connecting flange. The first shoulder can adjoin to the second shoulder, in particular in a stepped manner. The diameter, in particular the outer diameter, d2 of the second shoulder may be larger than the diameter, in particular the outer diameter d, of the substantially hollow-cylinder-like connecting body, in particular the attachment section, wherein d2>d may apply, and/or may be larger than the outer diameter d1 of the first shoulder, wherein d2>d1 may apply and in particular d2>d1>d. A different choice of these outer diameters d, d1, d2 is also conceivable. For example, the inner diameter a1 of the connecting flange can be adapted and/or matched to the outer diameter D1 and/or the inner diameter a2 of the connecting flange can be adapted and/or matched to the outer diameter D2.

The connecting flange can have a face side, in particular in its longitudinal direction, which is arranged and/or adapted for the arrangement and/or attachment of a sealing means, in particular a bellows seal.

The pre-mountable control rod assembly may comprise a bellows seal which extends at least sectionally between the control element sided end section, in particular of the substantially elongated control rod body, and the connecting flange.

The bellows seal may have a fold-like structure having one or more bellows which in particular string together in a wave-like form, wherein the fold-like structure is in particular arranged and adapted to expand and/or compress, in particular to compensate for movability and/or pressure changes, wherein in particular the bellows seal is adapted to provide a stroke, in particular during expansion and/or compression, in the range of in about 7.5 mm to in about 200 mm. The bellows seal can have a length in the range of approximately 150 mm to approximately 1200 mm, wherein in particular the bellows seal is produced from and/or comprises metal, in particular CrNi steels and/or nickel-based alloys.

The bellows seal can have a substantially elongated shape, for example with two ends. One end of the bellows seal can be, in particular directly, connected to the control rod body, in particular with a material connection, such as welded to it. The end at which the bellows seal is directly connected to the control rod body can be located at the control element sided end section of the control rod body. The bellows seal can be, at the end where the bellows seal is directly connected to the control rod body, connected to the control rod body in a sealing manner, in particular in the circumferential direction of the control rod body, continuously and/or circumferentially sealing. This enables improved sealing. Another end of the bellows seal can be, in particular directly, connected to the connecting flange, in particular with a material connection, such as welded. For example, the bellows seal can be attached or attachable to a face side of the connecting flange.

The bellows seal of the pre-mountable control rod assembly can extend at least sectionally between the control element sided end section, in particular of the substantially elongated control rod body, in particular the point at which the bellows seal is directly connected to the control rod body, and the point at which the bellows seal is connected to the connecting flange, in particular the face side.

An extension, in particular a width, in particular in a direction transversely to the axial direction of the control rod body, for example transversely to the stroke axis, in particular a diameter, such as an outer diameter, of the pre-mountable control rod assembly, can be smaller than a diameter of a penetration opening of a, in particular annular, mounting flange and/or one or more insert sleeves, in particular reversibly, attachable or attached to the mounting flange for providing the different valve function- and construction configurations.

For example, the outer dimension of the control rod body, for example its outer diameter; and/or the outer dimension of the connecting flange, for example the outer diameter of the substantially hollow-cylinder-like connecting body, in particular the attachment section and/or the engagement section, for example the first and/or second radial shoulder; and/or the outer diameter of the bellows seal, may be smaller than a diameter of the penetration opening of the mounting flange and/or the one or more insert sleeves, in particular reversibly attachable or attached to the mounting flange. In this way, it is possible, for example, to guide the mounting flange and/or the insert sleeve, for example afterwards, i.e. when the control rod assembly is already inserted in the control valve, e.g. in the valve housing, over the control rod assembly, for example to put it over in order to install and/or remove it. This facilitates assembly and enables or provides a modular arrangement.

The insert sleeve can have at least one channel or at least one opening, in particular a ventilation or venting opening, for example a ventilation or venting hole. The at least one opening can be located, for example, on a circumference or a circumferential surface of the insert sleeve.

One aspect of the disclosure relates to a coupling structure, in particular a lantern, for reception of the pre-mountable control rod assembly, in particular according to one or more of the aspects of the disclosure and/or embodiments described herein. For example, the pre-mountable control rod assembly may be inserted into, or surrounded by, the coupling structure. The coupling structure can also be designed for attachment, in particular detachably, between a valve housing and a housing cover of a control valve. The coupling structure can be a yoke and/or a lantern or the like of a control valve, which is arranged and/or adapted to connect or couple the valve housing and the housing cover, to protect it from external influences, and/or to separate the actuator side from the control element and/or the process fluid, i.e. to provide a greater distance between them.

The coupling structure, in particular the lantern, can comprise a substantially hollow-cylindrical base body with a through-opening. The through-opening can extend in the longitudinal direction of the coupling structure. The coupling structure can comprise several, for example flange-like, attachment sections. For example, on one side, for example a housing cover side, for example flange-like attachment sections may be provided for connecting and/or attaching a housing cover, and on another, for example opposite side, for example a valve housing sided, for example flange-like attachment sections may be provided for connecting and/or attaching a valve housing. Between the, for example flange-like, attachment sections, the coupling structure can have a substantially constant outer diameter. However, this can also widen in the direction of the valve housing, for example to provide greater stability and/or robustness; however, this is optional.

The through-opening can have a varying internal cross-section, for example a varying inner diameter, which can be designed and/or adapted, in particular for attaching a connecting flange. The internal cross-section, in particular the inner diameter, can decrease at least sectionally in the direction of a housing cover sided end section of the substantially hollow-cylindrical base body. The internal cross-section and/or the inner diameter can be matched to the external shape and/or one or more outer diameters, in particular the shoulders of the connecting flange, in particular shape-matched. The internal cross-section and/or the inner diameter of the through-opening of the coupling structure can change, for example reduce in size, for example, gradually, such as in a stepped manner.

The through-opening on the housing cover sided end section of the substantially hollow-cylindrical base body can define a connecting flange receiving opening. The connecting flange receiving opening may define one or more steps. A diameter of the one or more steps of the connecting flange receiving opening may be smaller than an inner diameter b of the through-opening. For example, the connecting flange receiving opening may have a first step with an inner diameter b1 that is smaller than the inner diameter b of the through-opening, wherein b1<b may apply. The connecting flange receiving opening may have a second step, which may in particular adjoin the first step, wherein the second step may have an inner diameter b2 which is smaller than the inner diameter b of the through-opening and/or the inner diameter b1 of the first step, wherein b2<b1<b may apply. A different choice of these inner diameters b, b1, b2 is also conceivable. The inner diameter b2 can at the same time have a receiving area for the substantially hollow-cylinder-like connecting body of the connecting flange, in particular its attachment section, e.g. for its outer diameter d.

The substantially hollow-cylindrical base body can have at least one recess, in particular a cutout, on a housing cover sided end face, in particular on the outside, for reception of a mounting element, in particular a union nut, in particular for tensioning a connecting flange, for example by means of its attachment section.

One aspect of the disclosure relates to a coupling structure, in particular a lantern, for reception of the pre-mountable control rod assembly, in particular according to one or more of the aspects of the disclosure and/or embodiments described herein. For example, the pre-mountable control rod assembly may be inserted into, or surrounded by, the coupling structure. The coupling structure can also be designed for attachment, in particular detachably, between a valve housing and a housing cover of a control valve. The coupling structure can be a yoke and/or a lantern or the like of a control valve, which is arranged and/or adapted to connect or couple the valve housing and the housing cover, to protect it from external influences, and/or to separate the actuator side from the control element and/or the process fluid, i.e. to provide a greater distance between them.

The coupling structure, in particular the lantern, can comprise a substantially hollow-cylindrical base body with a through-opening. The through-opening can extend in the longitudinal direction of the coupling structure. The coupling structure can comprise several, for example flange-like, attachment sections. For example, on one side, for example a housing cover side, for example flange-like attachment sections may be provided for connecting and/or attaching a housing cover, and on another, for example opposite side, for example a valve housing sided, for example flange-like attachment sections may be provided for connecting and/or fastening a valve housing. Between the, for example flange-like, attachment sections, the coupling structure can have a substantially constant outer diameter. However, this can also widen in the direction of the valve housing, for example to provide greater stability and/or robustness; however, this is optional.

The substantially hollow-cylindrical base body can have at least one channel, in particular a through channel, in particular for optional leakage measurement, at the housing cover sided end section. The at least one through channel can extend, in particular radially, outwards through the hollow cylindrical base body, in particular the coupling structure, in particular completely. The at least one through-channel can also extend through a, for example flange-like, attachment section of the coupling structure. The at least one through-channel can open into a recess, in particular a cutout arranged on the housing cover sided end face, in particular on the outside, for reception of a mounting element, in particular a union nut, in particular for a connecting flange. The cross-section and/or the inner diameter of the at least one through-channel can be constant or can decrease or increase, in particular gradually, such as in a stepped manner. A tapering or widening cross-section would also be conceivable. For example, the inner diameter of the at least one through-channel can change starting from the recess, in particular the cutout, for example increasing and/or decreasing, in particular in a direction radially outwards through the hollow cylindrical base body, in particular the coupling structure. The at least one through channel can be dimensioned with respect to a height of the recess, in particular the cutout, in order to be able to open into the recess, for example. The inner diameter c1 can increase radially outwards to an inner diameter c2, which can be designed as a threaded hole. A leakage measurement can be carried out using a pressure gauge or a volumetric flow meter, for example. The measuring device can, for example, be screwed directly into the threaded hole c2 or connected by means of a pipe connection. There is at least one vent hole in the insert sleeve. The mounting means, in particular the union nut, can be arranged in a first recess. Furthermore, a second and/or third recess can be provided, which can be designed for reception of a sealing means, for example for sealing the connecting flange receiving opening and/or for sealing between the coupling structure, in particular the lantern and the housing cover. The second and/or third recess can, for example, directly adjoin the recess, in particular in a stepped manner.

One aspect of the disclosure relates to a coupling structure, in particular a lantern, for reception of the pre-mountable control rod assembly, in particular according to one or more of the aspects of the disclosure and/or embodiments described herein. For example, the pre-mountable control rod assembly may be inserted into, or surrounded by, the coupling structure. The coupling structure can also be designed for attachment, in particular detachably, between a valve housing and a housing cover of a control valve. The coupling structure can be a yoke and/or a lantern or the like of a control valve, which is arranged and/or adapted to connect or couple the valve housing and the housing cover, to protect it from external influences, and/or to separate the actuator side from the control element and/or the process fluid, i.e. to provide a greater distance between them.

The coupling structure, in particular the lantern, can comprise a substantially hollow-cylindrical base body with a through-opening. The through-opening can extend in the longitudinal direction of the coupling structure. The coupling structure can comprise several, for example flange-like, attachment sections. For example, on one side, for example a housing cover side, for example flange-like attachment sections may be provided for connecting and/or attaching a housing cover, and on another, for example opposite side, for example a valve housing sided, for example flange-like attachment sections may be provided for connecting and/or attaching a valve housing. Between the, for example flange-like, attachment sections, the coupling structure can have a substantially constant outer diameter. However, this can also widen in the direction of the valve housing, for example to provide greater stability and/or robustness; however, this is optional.

The substantially hollow-cylindrical base body, in particular on a valve housing sided end face, can have a projection, in particular a fixing projection. The projection can be a circumferential projection. The projection can be dimensioned and/or arranged, in particular in relation to a radial position of the longitudinal axis of the coupling structure, such that, in particular in the assembled state of the coupling structure, in particular the lantern, in particular on the valve housing, it projects at least partially into the valve housing. The projection can contact, in particular bear against, the mounting flange and/or one or more insert sleeves insertable therein, e.g. in a form-fitting and/or force-fitting manner, in particular to provide contact pressure for the mounting flange arrangeable therein and/or one or one or more insert sleeves insertable therein. The projection can have a substantially stepped shape, in particular with one or more protrusions, for example for the arrangement of one or more sealing means. For example, the projection can have a first protrusion with an outer diameter e1. Alternatively, or additionally, the projection can have a second protrusion with an outer diameter e2. Alternatively, or additionally, the projection can have a third protrusion with an outer diameter e3. The outer diameter e2 of the second protrusion may be larger than the outer diameter e1 of the first protrusion, wherein e1<e2 may apply. The outer diameter e3 of the third protrusion may be larger than the outer diameter e1 of the first protrusion and/or than the outer diameter e2 of the second protrusion, wherein e1<e2<e3 may apply. A different choice of these outer diameters e1, e2, e3 is also conceivable. The height of the protrusions can be identical or different and/or, in particular, can be selected such that, for example in an assembled state of the coupling structure on the valve housing, a contact pressure is provided for the mounting flange and/or the insert sleeve that can be inserted therein.

An inner diameter b of the through-opening, in particular of the coupling structure, in particular of the lantern, can be dimensioned and/or formed in such a way that a distance e to a bellows seal that can be placed in it is provided. The distance e can, for example, result from the difference between the outer diameter of the bellows seal and the inner diameter b of the through-opening of the coupling structure.

One aspect of the disclosure relates to a control valve for adjusting a process fluid flow of a process plant, such as a chemical plant, a power plant, a food processing plant, or the like, wherein the control valve comprises: a valve housing having an inlet opening and an outlet opening, and a passage opening arranged therebetween; a housing cover arranged opposite the passage opening and having a through-opening, and a pre-mountable control rod assembly according to one or more of the aspects of the disclosure and/or embodiments described herein, for providing the modular control valve with a plurality of different valve function- and construction configurations.

One aspect of the disclosure relates to a control valve, in particular according to one or more of the aspects of the disclosure and/or embodiments described herein, for adjusting a process fluid flow of a process plant, such as a chemical plant, a power plant, a food processing plant, or the like, wherein the control valve comprises: a valve housing having an inlet opening and an outlet opening, as well as a passage opening arranged therebetween; a housing cover arranged opposite the passage opening and having a through-opening, and a coupling structure, in particular a lantern, according to one or more of the aspects of the disclosure and/or embodiments described herein, between the valve housing and the housing cover.

The pre-mountable control rod assembly can be attached or attachable to the coupling structure, in particular the lantern, by means of the connecting flange, in particular by means of its attachment section and/or its engagement section. For this purpose, the connecting flange can, for example, be arranged on and/or in the connecting flange receiving opening, for example in a form-fit and/or form-complementary manner. The substantially hollow-cylinder-like connecting body of the connecting flange can protrude and/or project at least partially from the coupling structure, in particular the lantern, in particular from the connecting flange receiving opening. The at least one first shoulder, in particular the first radial shoulder, of the connecting flange can, in particular on the inner side, bear against and/or engage the one or more steps of the connecting flange receiving opening, in particular in a form-fit and/or form-complementary manner. The substantially hollow-cylinder-like connecting body of the connecting flange, in particular its attachment section, can be attachable, in particular clampable, to the coupling structure, in particular the lantern, by means of a mounting element, in particular a union nut. For example, the connecting flange can be tensioned and/or clamped by screwing or tightening the union nut to the coupling structure and/or in its connecting flange receiving opening. In an attached state, the mounting element, in particular the union nut, can lie in the, in particular on the outside, recess of the housing cover sided end face. Among other things, this can save material and/or space or mounting space.

As already mentioned, the control valve can comprise an annular mounting flange and/or insert sleeve that can be inserted into the valve housing. The projection, in particular the one or more protrusions, of the coupling structure, in particular the lantern, can, in particular in an assembled state, project at least partially into the valve housing and press the mounting flange and/or the insert sleeve insertable therein, in particular in the axial direction, against the valve housing, in particular tensioning it therein, such as clamping it therein. In this way, the coupling structure can provide a, in particular axial, contact pressure which can result from the attachment of the coupling structure to the valve housing. This contact pressure can provide additional securing, for example positional securing in the axial and/or radial direction, for the mounting flange and/or the insert sleeve that can be inserted into it.

The control valve can comprise at least one first in particular on the housing cover sided, sealing means, for example for sealing between the connecting flange and the coupling structure, in particular the lantern, in particular for sealing the connecting flange receiving opening. For example, the first sealing means may be a ring seal, such as made of graphite. The first sealing means can, for example, be arranged between the second radial shoulder of the connecting flange, in particular the engagement section, and the first step of the through-opening of the coupling structure, in particular the lantern, in particular the connecting flange receiving opening.

Alternatively, or additionally, the control valve can comprise at least one second, in particular housing cover sided, sealing means for sealing the connecting flange receiving opening and/or for sealing between the coupling structure, in particular the lantern, and the housing cover. For example, the second sealing means can be a ring seal, such as made of graphite. The second sealing means can, for example, be arranged between the second and/or third recess of the recess arranged on the housing cover sided end face, in particular on the outside, and the housing cover, for example a shoulder of the housing cover. The at least one channel for leakage measurement can extend between the first and second sealing means or extend between them, for example radially outwards through the coupling structure, in particular the substantially hollow-cylindrical base body.

The control valve can comprise at least one first, in particular valve housing sided, sealing means for sealing between the mounting flange and the coupling structure, in particular the lantern, in particular for sealing between the mounting flange and the, in particular step-like projection. The sealing means can, for example, be arranged between the first protrusion of the projection and the mounting flange.

Alternatively, or additionally, the control valve can comprise at least a second, in particular valve housing sided, sealing means for sealing between the coupling structure, in particular the lantern, and the valve housing. The sealing means can, for example, be arranged between the second protrusion of the projection and the valve housing.

One aspect of the disclosure relates a method of assembling a control valve, in particular according to one or more of the aspects of the disclosure and/or embodiments described herein, may comprise:
inserting a pre-mountable control rod assembly according to one or more of the aspects of the disclosure and/or embodiments described herein;
guiding a penetration opening of a mounting flange and/or one or more insert sleeves, in particular reversibly, attachable or attached to the mounting flange through the pre-mountable control rod assembly; and
placing the coupling structure, in particular the lantern, according to one or more of the aspects of the disclosure and/or embodiments described herein, on the pre-mountable control rod assembly.

The method may include mounting one or more sealing means to:
the connecting flange, in particular on the outside, in particular on the at least one second shoulder, in particular the second radial shoulder, for sealing the connecting flange receiving opening, and/or
the mounting flange, in particular for sealing between the projection of the coupling structure, in particular the lantern, and the mounting flange, and/or
the valve housing, in particular for sealing between the coupling structure, in particular the lantern, and the valve housing.

The mounting of the sealing means may be before placing on the coupling structure, in particular the lantern.

The method may further comprise: fastening, in particular screwing, the coupling structure, in particular the lantern, to the valve housing, in particular after placing on the coupling structure, in particular the lantern.

The method may further comprise:
inserting the connecting flange, in particular the substantially hollow-cylinder-like connecting body, into the connecting flange receiving opening, and/or
fastening, in particular screwing, a mounting element, such as a union nut, to the substantially hollow-cylinder-like connecting body of the connecting flange, in particular the attachment section which protrudes and/or projects at least partially from the connecting flange receiving opening, for fastening the pre-mountable control rod assembly to the coupling structure, in particular the lantern.

The method may further comprise: fastening, in particular screwing, the housing cover to the coupling structure, in particular the lantern, and applying sealing means between the housing cover and the coupling structure, in particular the lantern, in particular before fastening the housing cover.

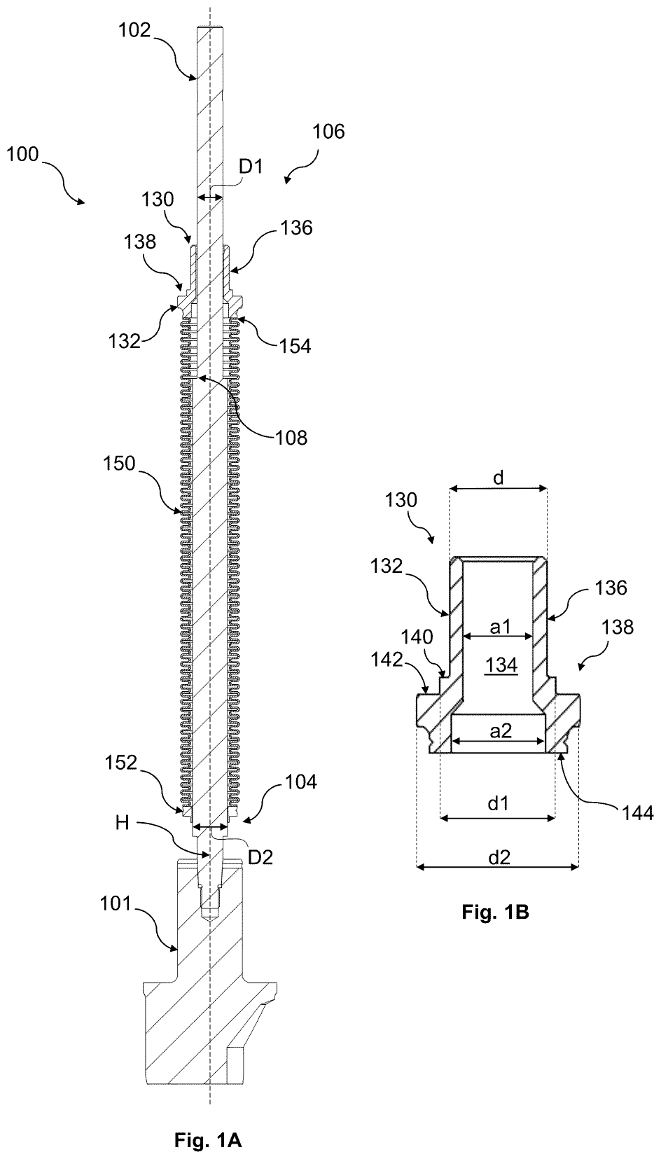

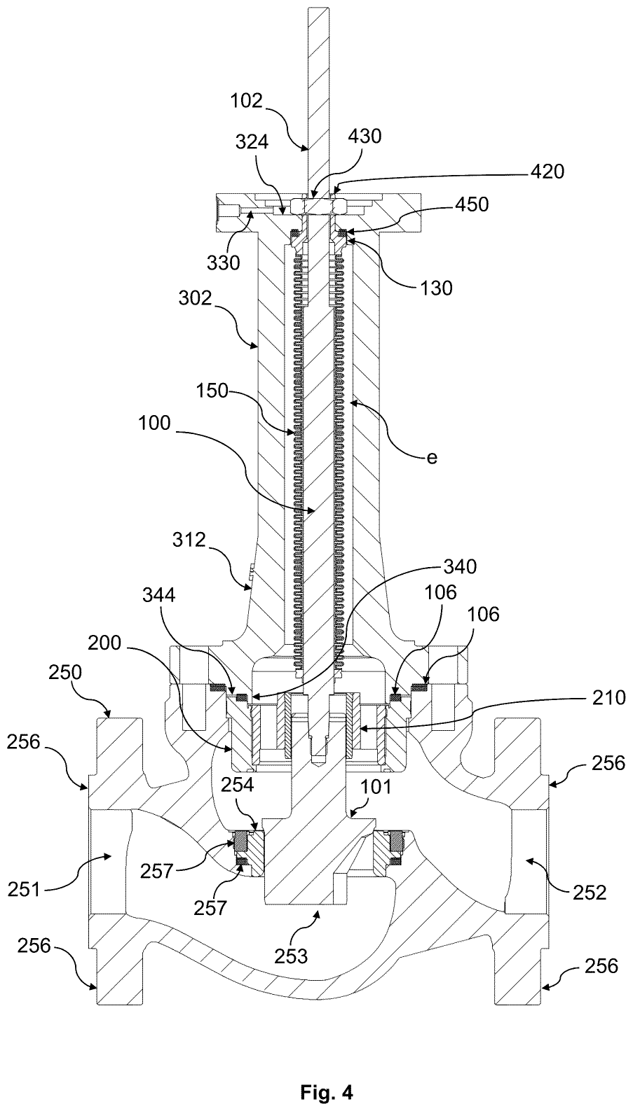

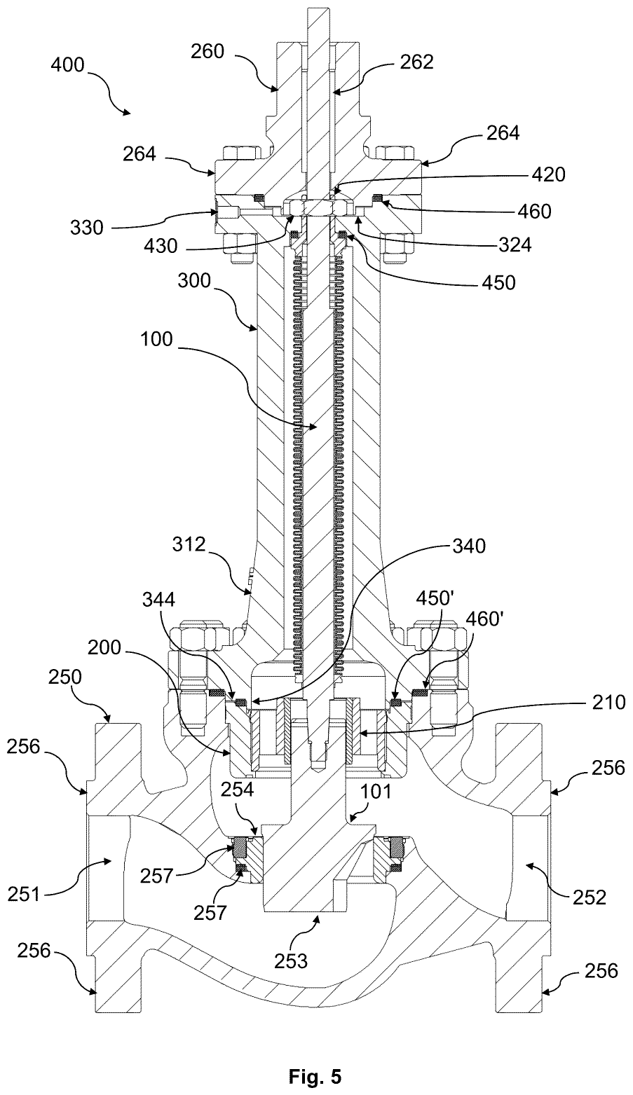

FIG. 1A shows a pre-mountable control rod assembly 100 outside the control valve, which has thus been pre-mounted or assembled, for example, before the intended use and/or the intended place of use, for example the final mounting position in the control valve 400 (see e.g. FIGS. 4-5). The control rod assembly 100 can therefore be inserted into the control valve, for example the valve housing, for example at a later time, which facilitates assembly and provides greater flexibility.

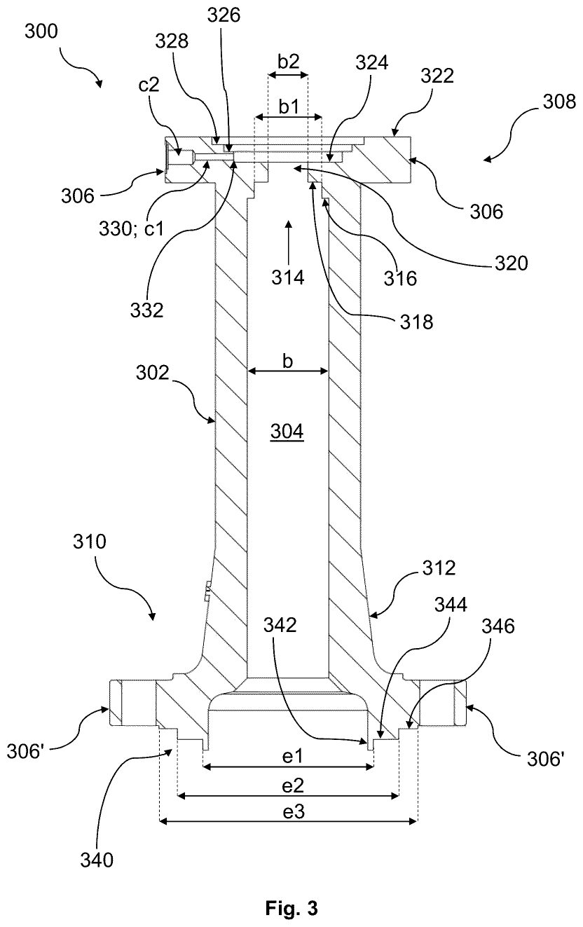

The pre-mountable control rod assembly 100 may have a substantially elongated control rod body 102. The control rod body 102 extends in the direction of and/or along the stroke axis H, which herein may simultaneously define the longitudinal direction L and/or the axial direction A of the control rod body 102 and/or the pre-mountable control rod assembly 100 and/or the connecting flange 130 (see FIG. 1B) and/or the coupling structure 300 (see FIG. 3) and/or the control valve 400 (see FIG. 5).

The substantially elongated control rod body 102 can have two, in particular opposite, end sections 104, 106. Several, in particular different and/or identical, control elements 101 can be attachable to one end section 104 of the substantially elongated control rod body 102 for realizing different process flows. This end section 104 may therefore be referred to as the control element sided end section 104. The other end section 106 may be located, for example, in the region of the housing cover of the control valve and may be referred to as the housing cover sided end section. The substantially elongated control rod body 102 may have a constant cross-section and/or diameter, in particular outer diameter. The cross-section may also change, for example in the longitudinal direction, for example in an abrupt and/or stepped manner. The substantially elongated control rod body 102 may, for example, have an outer diameter D1 in a region, in particular a length region, which changes, for example in steps, to an outer diameter D2, wherein D1<D2 may apply. The jump in diameter is illustrated in FIG. 1A by the reference sign 108. As can be seen, for example, in FIGS. 4-5, the substantially elongated control rod body 102 can be dimensioned such that, for example after its assembly, it has the diameter D1 in the region of the housing cover and/or a housing cover sided end section of a coupling structure, in particular a lantern, and has the diameter D2 in a region of the valve housing and/or in a valve housing sided end section of the coupling structure, in particular the lantern.

As shown in FIG. 1A, the pre-mountable control rod assembly 100 may comprise a connecting flange 130, which is shown enlarged in FIG. 1B. The connecting flange 130 may be arranged and/or adapted for engaging and/or connecting, in particular attaching, the control rod body 102 to a coupling structure, in particular a lantern, attachable to a valve housing of the control valve, or a housing cover of the control valve. The connecting flange 130 may comprise a substantially hollow-cylinder-like connecting body 132. The connecting flange 130 and/or the substantially hollow-cylinder-like connecting body 132 may have a through-opening 134 which extends, for example, in the longitudinal direction thereof and/or in the direction of the stroke axis H. The inner diameter of the through-opening may be at least sectionally matching and/or adapted to the outer diameter of the control rod body, in particular shape-matched and/or shape-adapted, for example to provide a guide for the control rod body 102. The through-opening 134 may have a substantially constant cross-section and/or diameter. The cross-section and/or diameter a1 can also change, for example in the longitudinal direction and/or in the direction of the stroke axis H, for example increasing and/or widening. The change in cross-section and/or diameter of the connecting flange 130, in particular on the inner side, may be matching and/or adapted to the change in cross-section and/or diameter of the substantially elongated control rod body 102, in particular on the outside, for example for form-fit and/or form-complementary engagement. The connecting flange 130 may be arranged on a section of the substantially elongated control rod body 102 opposite the control element sided end section 104. For example, the connecting flange 130 may also be attached to the substantially elongated control rod body 102, for example in a sliding manner, so that it is for example in the longitudinal direction and/or or along the substantially elongated control rod body 102 movable, relocatable, dislocatable and/or shiftable or is guidable by it, for example translationally.

As can be seen in FIG. 1B, the connecting flange 130, in particular the substantially hollow-cylinder-like connecting body 132, may have an outer shape which is for engagement with and/or attachment to the coupling structure, in particular the lantern, or the housing cover of the control valve. For example, the substantially hollow-cylinder-like connecting body 132 can have a section, in particular an attachment section 136, with a, in particular in the longitudinal direction, substantially constant outer diameter d which is adapted for attaching to the coupling structure, in particular the lantern, or the housing cover of the control valve. The attachment section 136 can, for example, have a threaded section (not shown), in particular on the outside, for example for screwing to a mounting element such as a union nut (see, for example, FIGS. 4-5). The attachment section 136 may be adjoined by a further section, in particular an engagement section 138, which may have a larger outer diameter than the outer diameter d of the attachment section 136. The attachment section 136 and the engagement section 138 may be formed in one piece, in particular by the substantially hollow-cylinder-like connecting body 132, for example from the same material. The engagement section 136 may have an outer contour that is formed in steps, for example the engagement section may have one or more steps 140, 142 that have one or more, in particular different, diameters, in particular outer diameters, d1/d2.

As can be seen in FIG. 1B, the connecting flange 130, in particular the engagement section 136, can have, in particular on the outside, at least a first shoulder 140, in particular a first radial shoulder 140. The radial shoulder 140 can be designed and/or adapted for engagement, in particular in a form-fit and/or form-complementary manner, with the coupling structure, in particular the lantern, or the housing cover of the control valve (see, for example, FIGS. 4-5), for example via a correspondingly shaped section of the coupling structure, for example the connecting flange receiving opening 314 (see FIG. 3). The first shoulder 140 may be a circumferential shoulder that extends substantially around the entire circumference of the connecting flange 130. The diameter, in particular the outer diameter, d1 of the first shoulder 140 may be larger than the diameter, in particular the outer diameter d, of the substantially hollow-cylinder-like connecting body 102, in particular the attachment section 136, wherein d1>d may apply.

The connecting flange 130, in particular the engagement section 136, can have, in particular on the outside, at least one second shoulder 142, in particular a second radial shoulder 142, for reception of at least one sealing means (see, for example, FIGS. 4-5). The radial shoulder may be a circumferential shoulder that extends substantially around the entire circumference of the connecting flange 130. The first shoulder 140 may adjoin to the second shoulder 142, in particular in a stepped manner. The diameter, in particular the outer diameter, d2 of the second shoulder 142 may be larger than the diameter, in particular the outer diameter d, of the substantially hollow-cylinder-like connecting body 102, in particular the attachment section 136, wherein d2>d may apply, and/or may be larger than the outer diameter d1 of the first shoulder 140, wherein d2>d1 may apply and in particular d2>d1>d. Another choice of these outer diameters d, d1, d2 is also conceivable.

The connecting flange 130 can have, in particular in its longitudinal direction and/or in the direction of the stroke axis H, a face side 144 which is arranged and/or adapted for the arrangement and/or attachment of a sealing means, in particular a bellows seal 150.

The pre-mountable control rod assembly 100 may include a bellows seal 150 extending at least sectionally between the control element sided end section 104, in particular the substantially elongated control rod body 102, and the connecting flange 130.

The bellows seal 150 can have a fold-like structure comprising one or more bellows, which can in particular string together in a wave-like form, wherein the fold-like structure is in particular arranged and adapted to expand and/or compress, in particular to compensate for movability and/or pressure changes, wherein in particular the bellows seal is designed to provide a stroke, for example in the direction of the stroke axis H, in particular during expansion and/or compression, in the range of approximately 7.5 mm to approximately 200 mm. The bellows seal 150 can have a length in the range of approximately 150 mm to approximately 1200 mm, wherein in particular the bellows seal is produced from and/or comprises metal, in particular CrNi steels and/or nickel-based alloys.

The bellows seal 150 may have a substantially elongated shape, for example with two ends 152, 154. One end 152 of the bellows seal 150 may be, in particular directly, connected to the control rod body 102, in particular with a material connection, such as welded thereto. The end 152, at which the bellows seal 150 is directly connected to the control rod body 102, may be located at the control element sided end section 104 of the control rod body 102. The bellows seal 150 may be, at the end 152 at which the bellows seal 150 is directly connected to the control rod body 102, connected to the control rod body 102 in a sealing manner, in particular in the circumferential direction of the control rod body 102, continuously and/or circumferentially sealing. This enables improved sealing. Another end 154 of the bellows seal can be, in particular directly, connected to the connecting flange 130, in particular with a material connection, such as welded. For example, the bellows seal 150 can be attached or attachable to a face side 144 of the connecting flange 130.

The bellows seal 150 of the pre-mountable control rod assembly 100 can extend at least sectionally between the control element sided end section 104, in particular of the substantially elongated control rod body 102, in particular the point 152 at which the bellows seal 150 is directly connected to the control rod body 100, and the point 154 at which the bellows seal 150 is connected to the connecting flange 130, in particular the face side 144.

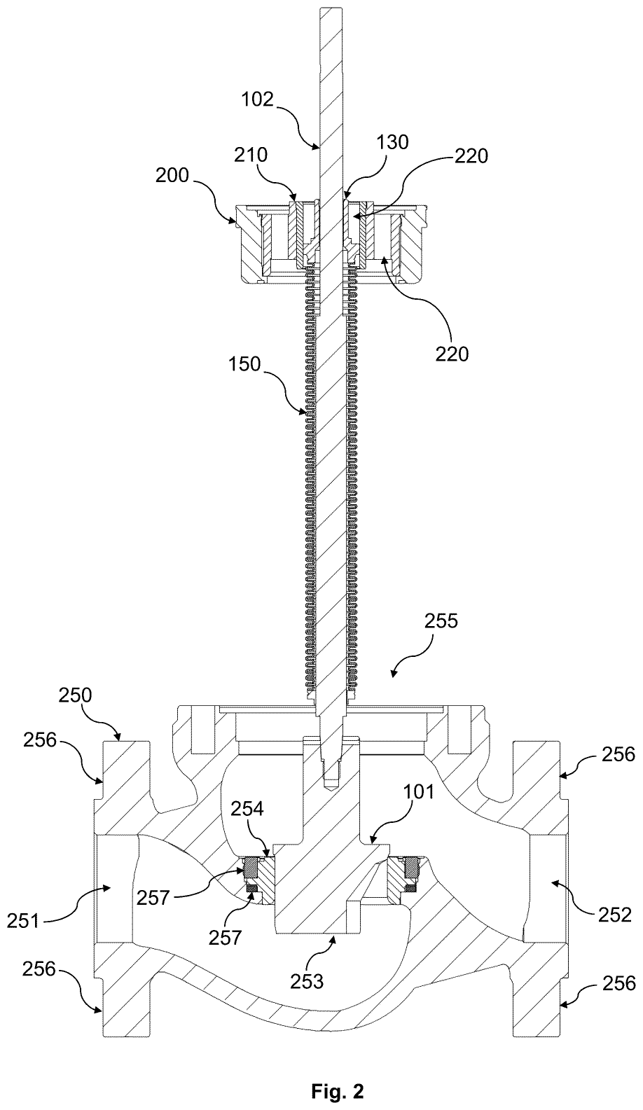

As can be seen in FIG. 2, an extension, in particular a width, in particular in a direction transversely to the axial direction of the control rod body 102 (for example transversely to the stroke axis H or longitudinal axis), in particular a diameter, such as an outer diameter, of the pre-mountable control rod assembly 100, may be smaller than a diameter of a penetration opening 220 of a, in particular annular, mounting flange 200 and/or one or more insert sleeves 210, in particular reversibly, attachable or attached to the mounting flange 200 for providing the different valve function- and construction configurations.

For example, the outer dimension of the control rod body 102, for example its outer diameter (D1 and/or D2, see FIG. 1A); and/or the outer dimension of the connecting flange 130, for example the outer diameter (d, d1 and/or d2, see FIG. 1B) of the substantially hollow-cylinder-like connecting body 132, in particular the attachment section 136 and/or the engagement section 138, for example the first and/or second radial shoulder 140, 142; and/or the outer diameter of the bellows seal 150 (see FIG. 2), may be smaller than a diameter of the penetration opening 220 of the mounting flange 200 and/or of the one or more insert sleeves 210, in particular reversibly, attachable or attached to the mounting flange 200. As indicated in FIG. 2, it is thereby possible to guide the mounting flange 200 and/or the insert sleeve 210, for example afterwards, i.e. when the control rod assembly 100 is already inserted in the control valve, e.g. in the valve housing 250, over the control rod assembly 100, for example to put it over in order to install and/or remove it. This can facilitate assembly and enable or provide a modular arrangement.

FIG. 2 further shows a valve housing 250 with an inlet opening 251 and an outlet opening 252 as well as a passage opening 253 arranged therebetween (see also FIGS. 4-5). Furthermore, a valve seat 254 is provided in the valve housing 250, which surrounds the passage opening 253. The valve seat 254 may be fully circular. The valve housing 250 further includes a movable control element 101 that is attached to a pre-mountable control rod assembly 100 described herein. The control element 101 can be brought into sealing engagement with the valve seat 254. As embodied above, the pre-mountable control rod assembly 100 may be designed as a modular adapter system and may be compatible with several different and/or similar control elements. For example, the pre-mountable control rod assembly 100 may comprise a plurality of different and/or similar control elements, in particular all of which are assembly-compatible therewith, for example to realize or provide several different, in particular individual, valve function- and construction configurations and/or to realize a modular control valve. The valve seat 254 and the control element 101 can be matching for a sealing engagement. The actuator 101 can be translationally movable along a stroke axis H (see FIG. 1A) and comprise a globe valve member, for example a valve piston or valve plug. The control element 101 can be adapted to adjust a process fluid flow of a process plant. The control valve can be equipped with an insert arrangement for guiding the control element, for example with a mounting flange 200, which can be inserted into the valve housing and can comprise a reversibly attachable or attached insert sleeve 210 for guiding the control element 101. The insert sleeve 210 can have at least one channel or at least one opening, such as a ventilation or venting opening, for example a ventilation or venting bore. The at least one opening can be located, for example, on a circumference or a circumferential surface of the insert sleeve 210.

The valve housing 250 according to FIGS. 2 and 4-5 can comprise an actuation opening 255 for inserting the control element 101 and/or a control rod and/or a pre-mountable control rod assembly 100 described herein for actuating the control element 101 along the stroke axis H. At the process fluid inlet and at the process fluid outlet of the valve housing 250, mounting devices 256, for example flange-like mounting devices 256, can be provided for connecting a pipeline for guiding process fluid. A valve seat 254 can be provided at the process fluid passage of the valve housing 250, which can cooperate with the control element 101 in a closing and/or opening manner. The valve seat 254 may be an annular and/or case-shaped seat of an insertable component. The valve seat 254 can have one or more sealing surfaces 257 for sealing cooperation with the control element 101, in particular a valve piston or valve plug. A sealing device 257, such as a ring seal, may be arranged between the valve seat 254 and the valve housing 250.

FIG. 3 shows a coupling structure 300 according to the disclosure, in particular a lantern 300 according to the disclosure, for reception of the pre-mountable control rod assembly 100, in particular according to one or more of the aspects of the disclosure and/or embodiments described herein. For example, the pre-mountable control rod assembly 100 described herein may be introduced into, and/or inserted into, or surrounded by, the coupling structure 300. The coupling structure 300 can also be designed for attachment, in particular detachably, between a valve housing 250 and a housing cover 260 of a control valve 400 (see FIG. 5). The coupling structure 300 can be a yoke and/or a lantern or the like, of a control valve 400, which is arranged and/or adapted to connect or couple the valve housing 250 and the housing cover 260, to protect it from external influences, and/or to separate the actuator side from the control element 101 and/or the process fluid, i.e. to provide a greater distance therebetween.

The coupling structure 300, in particular the lantern 300 shown in FIG. 3, can comprise a substantially hollow-cylindrical base body 302 with a through-opening 304. The through-opening 304 may extend in the longitudinal direction of the coupling structure 300, for example in the direction of the stroke axis H of FIG. 1A. The coupling structure 300 can comprise several, for example flange-like, attachment sections 306, 306′. For example, on one side, for example a housing cover side 308, for example flange-like attachment sections 306 may be provided for connecting and/or fastening a housing cover 260, and on another, for example opposite side, for example a valve housing side 310, for example flange-like attachment sections 306′ may be provided for connecting and/or fastening a valve housing sided 250. Between the, for example flange-like, attachment sections 306, 306′, the coupling structure 300 may have a substantially constant outer diameter. However, this can also widen in the direction of the valve housing 250, which is made clear by the reference sign 312, for example to provide greater stability and/or robustness; however, this is optional.

The through-opening 304 can have a varying internal cross-section, for example a varying inner diameter, which can be designed and/or adapted, in particular for attaching a connecting flange 130. The internal cross-section, in particular the inner diameter, can decrease at least sectionally in the direction of a housing cover sided end section 308 of the substantially hollow-cylindrical base body 302. The internal cross-section and/or the inner diameter can be matched to the external shape and/or one or more outer diameters, in particular the shoulders 140, 142 of the connecting flange 130 (see FIG. 1B), in particular shape-matched. The internal cross-section and/or the inner diameter of the through-opening 304 of the coupling structure 300 can change, for example gradually, such as in a stepped manner, for example decrease in size.

The through-opening 304 at the housing cover sided end section 308 of the substantially hollow-cylindrical base body 302 of FIG. 3 may define a connecting flange receiving opening 314. The connecting flange receiving opening 314 may define one or more steps 316, 318. A diameter of the one or more steps 316, 318 of the connecting flange receiving opening 314 may be smaller than an inner diameter b of the through-opening 304. For example, the connecting flange receiving opening 314 may include a first step 316 having an inner diameter b1 that is smaller than an inner diameter b of the through-opening 304, wherein b1<b may apply. The connecting flange receiving opening 314 may have a second step 318, which may in particular adjoin the first step 316, wherein the second step 318 may have an inner diameter b2 that is smaller than the inner diameter b of the through-opening 304 and/or the inner diameter b1 of the first step 316, wherein b2<b1<b may apply. A different choice of these inner diameters b, b1, b2 is also conceivable. The inner diameter b2 can simultaneously comprise a receiving region 320 for the substantially hollow-cylinder-like connecting body 132 of the connecting flange, in particular its attachment section 136, e.g. for its outer diameter d (see e.g. FIG. 1b).

The substantially hollow-cylindrical base body 302 can have, on or in a housing cover sided end face 322, in particular on the outside, at least one recess, in particular notch or cut-out 324, for reception of a mounting element, in particular a union nut (see e.g. FIGS. 4-5), in particular for tensioning a connecting flange 130, for example by means of its attachment section 136.

As shown in FIG. 3, the substantially hollow-cylindrical base body 302 can have at least one channel 330, in particular a through channel 330, at the housing cover sided end section 308 for optional leakage measurement. The at least one through channel 330 can extend, in particular radially, outwards through the hollow cylindrical base body 302, in particular the coupling structure 300, in particular completely. The at least one through-channel 330 can also extend through a, for example flange-like, attachment section 306 of the coupling structure 300. The at least one through-channel 330 can open into a recess 324, in particular notch or cut-out 324, arranged on a housing cover-sided end face 322, in particular on the outside, for reception of a mounting element, in particular a union nut (see FIGS. 4-5), in particular for a connecting flange 130. The point at which the at least one through-channel 330 opens into the recess 324 is illustrated by the reference sign 332. The cross-section and/or the inner diameter of the at least one through channel 330 can be constant or can decrease or increase, in particular gradually, such as in a stepped manner. A tapering or widening cross-section would also be conceivable. For example, the inner diameter of the at least one through-channel 330 can change starting from the recess 324, in particular the notch or cut-out 324, for example increasing and/or decreasing, in particular in a direction radially outwards through the hollow cylindrical base body 302, in particular the coupling structure 300. The at least one through-channel 330 can be dimensioned with respect to a height of the recess, in particular the cut-out, in order to be able to open into the recess 324, for example. The inner diameter c1 can increase, radially outwards, to an inner diameter c2, which can be designed as a threaded bore. A leakage measurement can be carried out, for example, by means of a pressure gauge or volumetric flow meter. The measuring device can, for example, be screwed directly into the threaded bore c2 or connected by means of a pipe connection. There is at least one vent hole in the insert sleeve 210. Further through passages (not shown in FIG. 3), for example two, three, four or more, may also be provided, for example distributed at even or uneven intervals and/or arranged in the circumferential direction of the end face 322. The recess 324 may also be configured in a stepped manner, i.e. comprising one or more recesses, notches and/or cutouts 324-328 of equal or different depths. For example, the mounting means, in particular the union nut, may be arranged in a first recess or cutout 324. Furthermore, a second and/or third recess or cutout 326, 328 may be provided, which may be designed for reception of a sealing means (see FIGS. 4-5), for example for sealing the connecting flange receiving opening 314 and/or for sealing between the coupling structure 300, in particular the lantern 300 and the housing cover 260.

As can be seen in FIG. 3, the substantially hollow-cylindrical base body 302 can have, in particular on a valve housing sided end face 310, a projection 340, in particular a fixing projection 340. The projection 340 can be a circumferential projection 340. The projection 340 can be dimensioned and/or arranged, in particular with respect to a radial position of the longitudinal axis or the stroke axis H of the coupling structure 300, such that, in particular in the assembled state of the coupling structure 300, in particular the lantern, in particular on the valve housing 250 (see, for example, FIGS. 4-5), it projects at least partially into the valve housing 250.

As can be seen in FIGS. 4-5, the projection 340 can contact the mounting flange 200 and/or one or more insert sleeves 210 insertable therein, in particular bear against it, e.g. in a form-fitting and/or force-fitting manner, in particular for providing a contact pressure for the mounting flange 200 arrangeable therein and/or one or more insert sleeves 210 insertable therein. As can be seen in FIG. 3, the projection 340 can have a substantially stepped shape, in particular with one or more protrusions 342-346, for the arrangement one or more sealing means. For example, the projection 340 can have a first protrusion 342 with an outer diameter e1. Alternatively, or additionally, the projection 340 may have a second protrusion 344 with an outer diameter e2. Alternatively, or additionally, the projection 340 may have a third protrusion 346 with an outer diameter e3. The outer diameter e2 of the second protrusion 344 may be larger than the outer diameter e1 of the first protrusion 342, wherein e1<e2 may apply. The outer diameter e3 of the third protrusion 346 may be larger than the outer diameter e1 of the first protrusion 342 and/or than the outer diameter e2 of the second protrusion 344, wherein e1<e2<e3 may apply. A different choice of these outer diameters e1, e2, e3 is also conceivable. The height of the protrusion 342-346 can be identical or different and/or in particular can be selected such that, for example in an assembled state of the coupling structure 300 on the valve housing 250, a contact pressure is provided for the mounting flange 200 and/or the insert sleeve 210 that can be inserted therein. The protrusions 342-346 can directly adjoin one another.

An inner diameter of the through-opening 304, in particular of the coupling structure 300, in particular of the lantern, can be dimensioned and/or formed such that a distance e to a bellows seal 150, which can be placed therein, is provided (see, for example, FIG. 4). The distance e, as shown in FIG. 4, can result, for example, from the difference between the outer diameter of the bellows seal 150 and the inner diameter of the through-opening 304 of the coupling structure 300.

FIG. 5 shows a control valve 400 according to the disclosure, that may comprises the pre-mountable control rod assembly 100 from FIG. 1A and the additional, coupling structure 300 according to the disclosure, in particular the lantern, as shown in FIG. 3, which is arranged and/or is attached between the valve housing 250 and the housing cover 260. In other words, FIG. 5 differs from FIG. 4 by the housing cover 260.

The housing cover 260 (see e.g. FIG. 5) is arranged and adapted to cover the actuating opening. The housing cover 260 can have a through-opening 262 extending in the direction of the stroke axis H (see FIG. 1A) for receiving the control rod and/or the pre-mountable control rod assembly 100 described herein. In particular, the housing cover 260 may include an attachment section 264 for mounting an actuator, in particular a pneumatic actuator or yoke, a coupling structure 300, in particular a lantern 300 or the like for supporting an actuator. A corresponding attachment section 264 may also be provided on the valve housing 250. With respect to a control rod and/or the control rod or the control rod body of the pre-mountable control rod assembly 100, the housing cover 260 may be dimensioned such that the smallest clear width, in particular the smallest inner diameter, of the housing cover 260, in particular the through-opening, is larger than the outer diameter of the control rod and/or the control rod of the pre-mountable control rod assembly 100 in the region extending through the through-opening 262 of the housing cover 260. The housing cover 260 and the valve housing 250 are connected via a coupling structure 300, in particular a lantern, therebetween.

The control valve 400 according to FIG. 5 is adapted to adjust a process fluid flow of a process plant, such as a chemical plant, a power plant, a food processing plant, or the like, and comprises: a valve housing 250 having an inlet opening 251 and an outlet opening 252, and a passage opening 253 arranged therebetween; a housing cover 260 arranged opposite the passage opening 253 and having a through-opening 262, and a pre-mountable control rod assembly 100 according to one or more of the aspects of the disclosure and/or embodiments described herein, for providing the modular control valve 400 with a plurality of different valve function- and construction configurations as described above. The control valve 400 further comprises a coupling structure 300, in particular a lantern, according to one or more of the aspects of the disclosure and/or embodiments described herein, between the valve body 250 and the housing cover 260. As shown in FIG. 5, the coupling structure 300 is attached to the valve body 250 and/or the housing cover 260 via threaded connections.

As shown in FIGS. 4-5, the pre-mountable control rod assembly 100 is attached to the coupling structure 300, in particular the lantern 300, by means of the connecting flange 130, in particular by means of its attachment section 136 and/or its engagement section 138. For this purpose, the connecting flange 130 can, for example, be arranged on and/or in the connecting flange receiving opening 314 (see FIG. 3), for example in a form-fit and/or form-complementary manner. The substantially hollow-cylinder-like connecting body 132 of the connecting flange 130 may protrude and/or project at least partially from the coupling structure 300, in particular the lantern 300, in particular from the connecting flange receiving opening 314. This is illustrated in FIGS. 4-5 by the reference sign 420. The at least one first shoulder 140, in particular the first radial shoulder 140, of the connecting flange 130 may bear against and/or engage the one or more steps 316, 318 of the connecting flange receiving opening 314, in particular in a form-fit and/or form-complementary manner, in particular on the inner side. For example, the shoulder 140 of the connecting flange 130 rests against the step 318 of the coupling structure 300 and the shoulder 142 rests against the step 316. The substantially hollow-cylinder-like connecting body 132 of the connecting flange 130, in particular its attachment section 136, can be attachable, in particular clampable, to the coupling structure 300, in particular the lantern, by means of a mounting element, in particular a union nut 430. For example, the connecting flange 300 can be tensioned and/or clamped by screwing or tightening the union nut 430 to the coupling structure 300 and/or in its connecting flange receiving opening 314. In an attached state, the mounting element, in particular the union nut 430, can lie in the, in particular on the outside, recess, notch and/or cutout 324 of the housing cover sided end face 322. Among other things, this can save material and/or space and/or mounting space.

As mentioned above, the control valve 400 may comprise an annular mounting flange 200 insertable into the valve body 250 and/or an insert sleeve 210. The projection 340, in particular the one or more protrusions 342-346, of the coupling structure 300, in particular the lantern 300, can, in particular in an assembled state, project at least partially into the valve housing 250 and press the mounting flange 200 and/or the insert sleeve 210 insertable therein, in particular in the axial direction, against the valve housing 250, in particular tensioning it therein, such as clamping it therein. In this way, the coupling structure 300 can provide a, in particular axial, contact pressure which can result from the attachment of the coupling structure 300 to the valve housing 250. This contact pressure can provide additional securing, for example positional securing in the axial and/or radial direction, for the mounting flange 200 and/or the insert sleeve 210 that can be inserted therein.

The control valve 400 can comprise at least a first, in particular housing cover sided, sealing means 450 for example for sealing between the connecting flange 130 and the coupling structure 300, in particular the lantern 300, in particular for sealing the connecting flange receiving opening 314. For example, the first sealing means 450 can be a ring seal, such as made of graphite. The first sealing means 450 may, for example, be arranged between the second radial shoulder 142 of the connecting flange 130, in particular the engagement section 138, and the first step 316 of the through-opening 304 of the coupling structure 300, in particular the lantern, in particular the connecting flange receiving opening 314.

Alternatively, or additionally, the control valve may comprise at least a second, in particular housing cover sided, sealing means 460 for sealing the connecting flange receiving opening 314 and/or for sealing between the coupling structure 300, in particular the lantern, and the housing cover 260. For example, the second sealing means 460 may be a ring seal, such as made of graphite. The second sealing means 460 may, for example, be arranged between the second and/or third recess 326, 328 of the recess 324 arranged on the end face 322 on the housing cover side, in particular on the outside, and the housing cover 260, for example a shoulder of the housing cover 260. The at least one channel 330 for leakage measurement can extend between the first and second sealing means 450, 460 or extend between them, for example radially outwards through the coupling structure 300, in particular the substantially hollow-cylindrical base body 302.

The control valve can comprise at least one first, in particular valve housing sided, sealing means 450′ for sealing between the mounting flange 200 and the coupling structure 300, in particular the lantern, in particular for sealing between the mounting flange 200 and the projection 340, in particular in a stepped manner. For example, the sealing means 450′ may be a ring seal, such as made of graphite. The sealing means 450′ may, for example, be arranged between the first protrusion 342 of the projection 340 and the mounting flange 200.

Alternatively, or additionally, the control valve may comprise at least a second, in particular valve housing sided, sealing means 460′ for sealing between the coupling structure 300, in particular the lantern, and the valve housing 250. For example, the sealing means 460′ may be a ring seal, such as made of graphite. The sealing means 460′ may, for example, be arranged between the second protrusion 344 of the projection 340 and the valve housing 250.

The features disclosed in the preceding description, the figures and the claims may be of importance both individually and in any combination for the realization of the disclosure in the various embodiments.

To enable those skilled in the art to better understand the solution of the present disclosure, the technical solution in the embodiments of the present disclosure is described clearly and completely below in conjunction with the drawings in the embodiments of the present disclosure. Obviously, the embodiments described are only some, not all, of the embodiments of the present disclosure. All other embodiments obtained by those skilled in the art on the basis of the embodiments in the present disclosure without any creative effort should fall within the scope of protection of the present disclosure.

It should be noted that the terms “first”, “second”, etc. in the description, claims and abovementioned drawings of the present disclosure are used to distinguish between similar objects, but not necessarily used to describe a specific order or sequence. It should be understood that data used in this way can be interchanged as appropriate so that the embodiments of the present disclosure described here can be implemented in an order other than those shown or described here. In addition, the terms “comprise” and “have” and any variants thereof are intended to cover non-exclusive inclusion. For example, a process, method, system, product or equipment comprising a series of steps or modules or units is not necessarily limited to those steps or modules or units which are clearly listed, but may comprise other steps or modules or units which are not clearly listed or are intrinsic to such processes, methods, products or equipment.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

### REFERENCE LIST

100 Control rod assembly
101 Control element
102 Control rod body
104 Control element sided end section
106 Housing cover sided end section
108 Diameter jump
130 Connecting flange
132 Connecting body
134 Through-opening
136 Attachment section
138 Engagement section
140, 142 Shoulders
144 Face side
150 Bellows seal
152 End of bellows seal
154 End of bellows seal
200 Mounting flange
210 Insert sleeve
220 Penetration opening
250 Valve body
251 Inlet opening
252 Outlet opening
253 Passage opening
254 Valve seat
255 Actuation opening
256 Mounting devices
257 Sealing device
260 Housing cover
262 Through-opening
300 Coupling structure
302 Base body
304 Through-opening
306, 306′ Attachment sections
310 End face
312 Widening
314 Connecting flange receiving opening
316, 318 Step
320 End face
322 End face
324, 326, 328 Recess
330 Through-channel
340 Projection
342, 344, 346 Protrusion
400 Control valve
420 Projecting connecting flange
430 Attachment element
450, 450′ Sealing means
460, 460′ Sealing means
D1, D2 Diameter
d1, d2 Diameter
a1 Diameter
b1, b2 Diameter
c1, c2 Diameter
e Distance
e1, e2, e3 Diameter
H Direction along stroke axis
L Longitudinal direction

1. A pre-mountable control rod assembly for providing a modular control valve having a plurality of different valve function- and construction configurations, the control valve being adapted to adjust a process fluid flow of a process plant, the control rod assembly comprising:
an elongated control rod body with a control element sided end section to which different control elements are attachable, the control elements being configured to realize different process flows;
a connecting flange arranged on a section of the elongated control rod body opposite the control element sided end section, wherein the connecting flange comprises a hollow-cylinder-like connecting body configured to engage and/or connect the control rod body to a coupling structure attachable to a valve housing of the control valve, or a housing cover of the control valve; and
a bellows seal that extends at least sectionally between the control element sided end section and the connecting flange, wherein a first end of the bellows seal is directly connected to the control rod body and a second end of the bellows seal is directly connected to the connecting flange.

2. The pre-mountable control rod assembly according to claim 1, wherein the first end of the bellows seal is located at the control element sided end section of the control rod body.

3. The pre-mountable control rod assembly according to claim 1, wherein the connecting flange has at least one first shoulder configured to engage with the coupling structure or the housing cover of the control valve.

4. The pre-mountable control rod assembly according to claim 3, wherein the connecting flange has at least one second shoulder configured to receive at least one seal, wherein the first shoulder adjoins the second shoulder.

5. The pre-mountable control rod assembly according to claim 1, wherein the bellows seal is, at the first end of the bellows seal, connected to the control rod body in a continuous and/or circumferentially sealing manner in the circumferential direction of the control rod body.

6. The pre-mountable control rod assembly according to claim 1, wherein the bellows seal comprises a fold-like structure having one or more bellows, wherein the bellows seal is configured to have a stroke in a range of 7.5 to 200 mm.

7. The pre-mountable control rod assembly according to claim 1, wherein the bellows seal has a length of 150 mm to 1200 mm, wherein the bellows seal is produced from and/or comprises metal.

8. The pre-mountable control rod assembly according to claim 1, wherein an extension of the pre-mountable control rod assembly is smaller than a diameter of a penetration opening of a mounting flange and/or one or more insert sleeves attachable or attached to the mounting flange and configured to provide the different valve function- and construction configurations.

9. A coupling structure for reception of a pre-mountable control rod assembly and for attachment between a valve housing and a housing cover of a control valve, the control valve being adapted to adjust a process fluid flow of a process plant, the coupling structure comprising:
a hollow-cylindrical base body with a through-opening, wherein:
the through-opening has a varying internal cross-section that decreases at least sectionally in a direction of a housing cover sided end section of the hollow-cylindrical base body, and
the hollow-cylindrical base body has at least one recess on an outside of a housing cover sided end face configured to receive a mounting element.

10. The coupling structure according to claim 9, wherein the through-opening at the housing cover sided end section of the hollow-cylindrical base body defines a connecting flange receiving opening.

11. A coupling structure for reception of a pre-mountable control rod assembly and for attachment between a valve housing and a housing cover of a control valve, the control valve being adapted to adjust a process fluid flow of a process plant, the coupling structure comprising:
a hollow-cylindrical base body with a through-opening, the hollow-cylindrical base body, on a valve housing sided end face, having a projection dimensioned and/or arranged such that, in an assembled state of the coupling structure, the projection projects at least partially into the valve housing.

12. A control valve for adjusting a process fluid flow of a process plant, the control valve comprising:
a valve housing with an inlet opening, an outlet opening, and a passage opening arranged therebetween;
a housing cover arranged opposite the passage opening with a through-opening; and
a pre-mountable control rod assembly according to claim 1 and configured to provide the modular control valve with a plurality of different valve function- and construction configurations, and/or a coupling structure between the valve housing and the housing cover, wherein the coupling structure comprises a hollow-cylindrical base body with a through-opening having a varying internal cross-section that decreases at least sectionally in the direction of a housing cover sided end section of the hollow-cylindrical base body, wherein the hollow-cylindrical base body has at least one recess on an outside of a housing cover sided end face configured to receive a mounting element.

13. The control valve according to claim 12, wherein the pre-mountable control rod assembly is attached or attachable to the coupling structure by the connecting flange.

14. The control valve according to claim 13, wherein the hollow-cylinder-like connecting body of the connecting flange protrudes at least partially from the coupling structure.

15. The control valve according to claim 14, wherein the hollow-cylinder-like connecting body of the connecting flange is attachable to the coupling structure by a mounting element, wherein the mounting element, in an attached state, lies in the outside recess of the housing cover sided end face.

16. The control valve according to claim 14, further comprising:
an annular mounting flange which is insertable in the valve housing, wherein a projection of the coupling structure projects at least partially into the valve housing and presses the mounting flange and/or an insert sleeve insertable therein in an axial direction against the valve housing.

17. The control valve according to claim 14, wherein the control valve comprises at least one first seal configured to seal between the connecting flange and the coupling structure, and/or at least one second seal configured to seal between the coupling structure and the housing cover.

18. The control valve according to claim 12, wherein the control valve comprises at least one first seal configured to seal between a mounting flange and the coupling structure, and/or at least one second seal configured to seal between the coupling structure and the valve housing.

19. A method of assembling a control valve, comprising:
inserting a pre-mountable control rod assembly according to claim 1 into a valve body;
guiding a penetration opening of a mounting flange and/or one or more insert sleeves attachable or attached to the mounting flange through the pre-mountable control rod assembly; and
placing a coupling structure on the pre-mountable control rod assembly.

20. The method of claim 19, further comprising: mounting one or more seals to:
the connecting flange to seal the connecting flange receiving opening,
the mounting flange, and/or
the valve housing,
wherein the one or more seals are mounted before placing on the coupling structure.

21. The method according to claim 19, further comprising: fastening the coupling structure to the valve housing after placing on the coupling structure.

22. The method according to claim 19, further comprising:
inserting the hollow-cylinder-like connecting body into the connecting flange receiving opening, and/or
fastening a mounting element to the hollow-cylinder-like connecting body of the connecting flange, which protrudes at least partially from the connecting flange receiving opening, to fasten the pre-mountable control rod assembly to the coupling structure.
